(19) United States
(12) Patent Application Publication
(10) Pub. No.: US 2025/0249963 A1
(43) Pub. Date: Aug. 7, 2025

(54) BRACKET

(71) Applicant: FUTABA INDUSTRIAL CO., LTD., Okazaki-shi (JP)

(72) Inventors: Akitoshi TSUGE, Okazaki-shi (JP); Yuya MIYANAGA, Okazaki-shi (JP)

(21) Appl. No.: 19/043,887

(22) Filed: Feb. 3, 2025

(30) Foreign Application Priority Data
Feb. 5, 2024 (JP) 2024-015913

(51) Int. Cl. B62D 27/02

(52) U.S. Cl. CPC B62D 27/02

(57) ABSTRACT

A bracket is configured to be mounted in a vehicle and includes a bottom surface, a bottom joining portion, a side wall, an upper joining portion, and an internal rib. The bottom joining portion is arranged at the bottom surface and configured to join a suspension member to the bottom surface. The side wall is a wall-shaped portion protruding upward from an edge portion of the bottom surface and surrounding the edge portion. The upper joining portion is arranged at an upper end of the side wall and configured to be joined to a framework of the vehicle. The internal rib protrudes upward from the bottom surface. The bracket is an integrally-formed member and formed of aluminum or aluminum alloy.

### CROSS-REFERENCE TO RELATED APPLICATIONS

The present application claims priority based on Japanese Patent Application No. 2024-015913 filed on Feb. 5, 2024 with the Japan Patent Office, the entire disclosure of which is incorporated herein by reference.

### BACKGROUND

The present disclosure relates to a bracket.

As described in Japanese Unexamined Patent Application Publication No. 2005-53431, there is a known technique in which a rear frame, which is a portion located around a rear wheel in a vehicle's framework, is composed of multiple metal plate members.

### SUMMARY

Unfortunately, the technique disclosed in the above publication may increase the number of components constituting the rear frame, and thereby may increase the assembly workload and the weight of the rear frame.

It is desirable that one aspect of the present disclosure provides a technique to facilitate reduction of the assembly workload and lightweighting.

One aspect of the present disclosure provides a bracket to be mounted in a vehicle. The bracket includes a bottom surface, a bottom joining portion, a side wall, an upper joining portion, and an internal rib. The bottom surface is configured to be arranged to face a suspension member. The bottom joining portion is arranged at the bottom surface and configured to join the suspension member to the bottom surface. The side wall is a wall-shaped portion protruding upward from an edge portion of the bottom surface and surrounding the edge portion. The upper joining portion is arranged at an upper end of the side wall and configured to be joined to a member constituting a portion of a framework of the vehicle. The internal rib is a wall-shaped portion protruding upward from the bottom surface. The bracket is an integrally-formed member and formed of aluminum or aluminum alloy.

With the above-described configuration, it is possible to reduce the number of components and facilitate improvement in the stiffness of the bracket. Furthermore, integrally forming the bracket using aluminum or aluminum alloy enables lightweighting. Thus, it is possible to facilitate reduction of the assembly workload and lightweighting.

In one aspect of the present disclosure, the internal rib may extend from the side wall to the bottom joining portion.

With the above-described configuration, it is possible to improve the stiffness of the bracket.

In one aspect of the present disclosure, the bracket may further include an external rib that is a wall-shaped portion protruding from an external lateral surface of the side wall and extending in a direction substantially aligns with an up-down direction.

With the above-described configuration, it is possible to improve the stiffness of the bracket.

In one aspect of the present disclosure, a lower end of the external rib may be located above the bottom surface.

With the above-described configuration, it is possible to facilitate lightweighting of the bracket.

In one aspect of the present disclosure, the bottom surface may be a substantially rectangular plate-shaped portion. The side wall may include four planar portions each protruding from a portion of the edge portion of the bottom surface, the portion of the edge portion forming a side of the edge portion.

With the above-described configuration, it is possible to facilitate improvement in the stiffness of the bracket.

In one aspect of the present disclosure, the upper joining portion may be a flange-shaped portion arranged at upper ends of the four planar portions of the side wall.

The above-described configuration enables the bracket to be joined in a preferred manner to a member constituting a portion of the framework of the vehicle.

In one aspect of the present disclosure, the upper joining portion may include a first upper joining portion and a second upper joining portion. The second upper joining portion is located laterally to the first upper joining portion. The first upper joining portion may be configured to be joined to a first member included in the framework of the vehicle. The second upper joining portion may be configured to be joined to a second member that is included in the framework of the vehicle and is different from the first member.

With the above-described configuration, it is possible to facilitate reduction of the assembly workload and lightweighting even in cases where the bracket is configured to be joined to multiple members.

In one aspect of the present disclosure, the side wall may include a long portion extending in a planar manner from the edge portion of the bottom surface to the first upper joining portion and the second upper joining portion.

With the above-described configuration, it is possible to improve the stiffness of the bracket.

In one aspect of the present disclosure, the bottom surface may be a substantially rectangular plate-shaped portion. The side wall may include two long portions each extending in a planar manner from a respective one of two portions of the edge portion of the bottom surface to the first upper joining portion and the second upper joining portion, the two portions of the edge portion forming long sides of the edge portion.

With the above-described configuration, it is possible to improve the stiffness of the bracket.

In one aspect of the present disclosure, the second upper joining portion may be located above the first upper joining portion. The two long portions may each include a first portion and a second portion, the first portion having a substantially rectangular shape and being located on an upper side of the bottom surface, the second portion having a substantially triangular shape and being located laterally to the first portion. The second portion may widen toward a top thereof. The first upper joining portion may be arranged at an upper end of the first portion, and the second upper joining portion may be arranged at an upper end of the second portion.

With the above-described configuration, it is possible to improve the stiffness of the bracket and join the bracket in a preferred manner to a member constituting a portion of the framework of the vehicle.

### BRIEF DESCRIPTION OF THE DRAWINGS

Example embodiments of the present disclosure will be described hereinafter with reference to the accompanying drawings, in which:

FIG. 1 is a side view of a front side of a bracket according to a first embodiment;

FIG. 2 is a side view of a rear side of the bracket according to the first embodiment;

FIG. 3 is a top view of the bracket according to the first embodiment;

FIG. 4 is a bottom view of the bracket according to the first embodiment;

FIG. 5 is a side view of an inner side of the bracket according to the first embodiment;

FIG. 6 is a side view of an outer side of the bracket according to the first embodiment;

FIG. 7 is a side view of a front side of a bracket according to a second embodiment;

FIG. 8 is a side view of a rear side of the bracket according to the second embodiment;

FIG. 9 is a top view of the bracket according to the second embodiment;

FIG. 10 is a bottom view of the bracket according to the second embodiment;

FIG. 11 is a side view of an inner side of the bracket according to the second embodiment; and

FIG. 12 is a side view of an outer side of the bracket according to the second embodiment.

### DETAILED DESCRIPTION OF EXEMPLARY EMBODIMENTS

### 1. First Embodiment

### (1) Overview

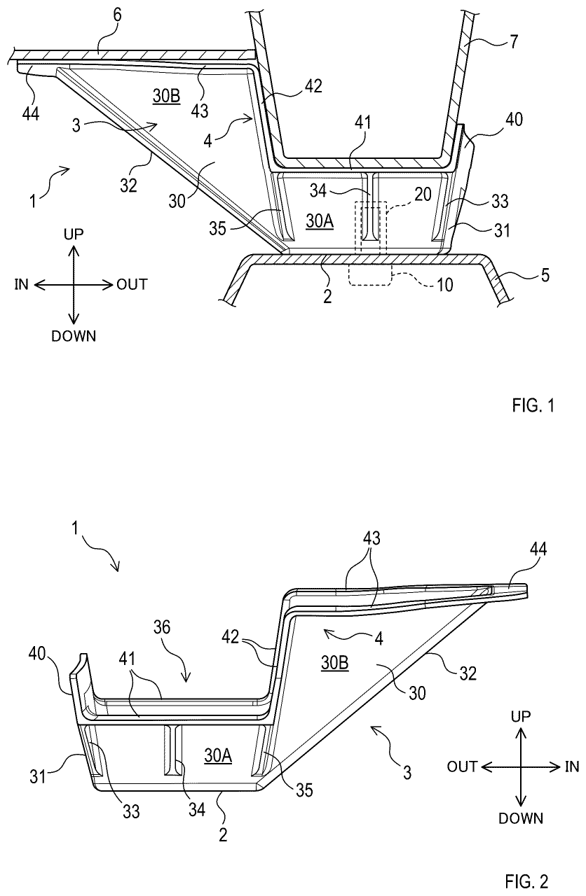

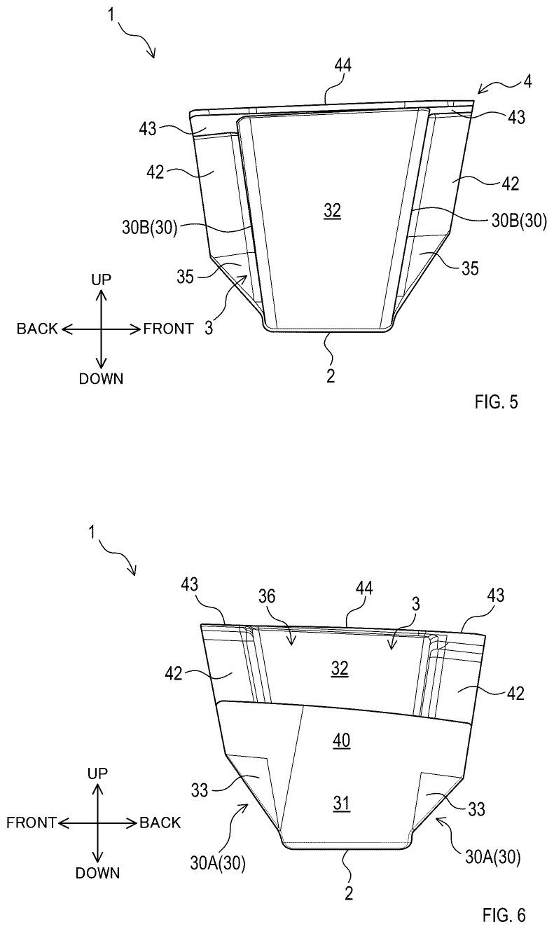

A bracket 1 according to a first embodiment is configured to be mounted in a left portion and a right portion of a vehicle for use in joining a suspension member 5 of the vehicle to a floor member 6 and side members 7 of the vehicle (see FIGS. 1 to 6). The suspension member 5 refers to one of framework members constituting a portion of a framework of the vehicle and is arranged around suspensions of rear wheels of the vehicle. The floor member 6 refers to a plate-shaped framework member located at the bottom of a space in the vehicle such as a cabin. The side member 7 refers to a frame-shaped framework member located on the left side and the right side of the vehicle and extending in the front-rear direction of the vehicle.

The bracket 1 is formed of aluminum or aluminum alloy and integrally formed by aluminum die casting. The bracket 1 may be integrally formed by other casting methods, such as a casting method using semi-solid aluminum.

The bracket 1 includes a bottom surface 2, a side wall 3, and an upper joining portion 4. The bracket 1 has an elongated shape and is configured to be mounted in the vehicle such that, for example, the long-axis direction of the bracket 1 substantially aligns with the left-right direction of the vehicle and the short-axis direction of the bracket 1 substantially aligns with the front-rear direction of the vehicle. In the following description, the central side and the end side of the vehicle in the left-right direction will be simply referred to as “inner side” and “outer side”, respectively. The orientation of the bracket 1 when mounted in the vehicle is not limited to the above-mentioned orientation and may be suitably determined.

### (2) Bottom Surface

The bottom surface 2 is, for example, a substantially rectangular plate-shaped portion extending in the long-axis direction of the bracket 1 and is configured to be arranged to face the suspension member 5 (see FIGS. 1 to 6). The shape of the bottom surface 2 is not limited to rectangular and may be suitably determined. The bottom surface 2 is provided with a bottom joining portion 20, a first and a second internal rib 21, 22.

### <Bottom Joining Portion>

The bottom joining portion 20 is configured to join the suspension member 5 to the bottom surface 2 (see FIGS. 1, 3, and 4). The bottom joining portion 20 is a cylindrical portion located substantially in the middle of the bottom surface 2 and extending upward. The bottom joining portion 20 has a closed top. The bottom joining portion 20 forms a circular hole substantially in the middle of the bottom surface 2 (see FIG. 4) and has a threaded inner circumferential surface. By inserting a bolt 10 in the bottom joining portion 20 from the lower side of the bottom surface 2, the bottom surface 2 and the suspension member 5 are joined to each other.

The bottom joining portion 20 may be formed, for example, as a bolt hole in the bottom surface 2. It is possible also in such a case to join the bottom surface 2 and the suspension member 5 using the bolt 10, inserted in the bottom joining portion 20, and a nut. The bottom joining portion 20 may be configured to join the bottom surface 2 and the suspension member 5 by means other than bolting.

### <First and Second Internal Ribs>

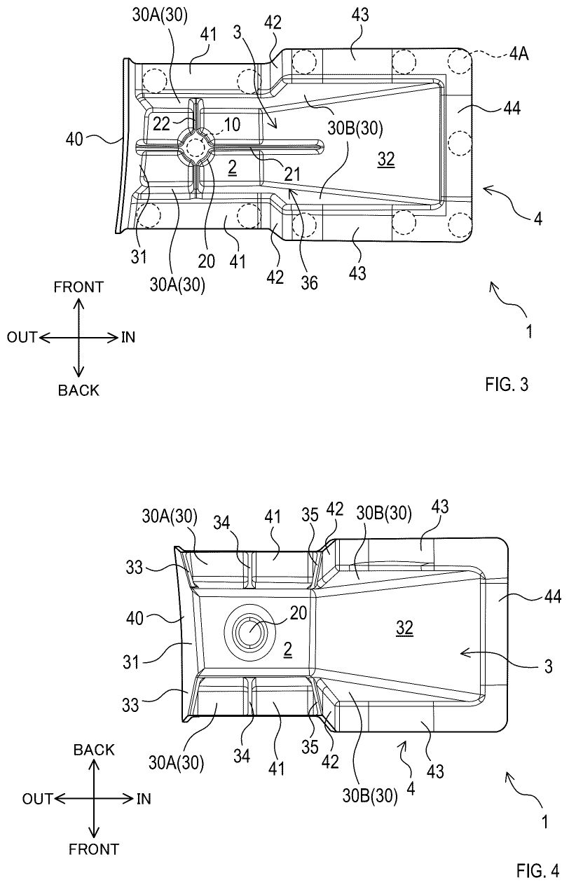

The first and the second internal ribs 21, 22 are wall-shaped portions located inside of the side wall 3, which will be described later, and protrude upward from the bottom surface 2. The first and the second internal ribs 21, 22 respectively extend linearly along the long-axis direction and the short-axis direction of the bracket 1 (see FIG. 3). In one example, each of the first and the second internal ribs 21, 22 has a substantially constant height which is from the bottom surface 2 to the top.

The first internal rib 21 extends in a substantially planar manner along the long-axis direction, and its ends in the long-axis direction are respectively connected to a first and a second short portion 31, 32 of the side wall 3, which will be described later. The second internal rib 22 extends in a substantially planar manner along the short-axis direction, and its ends in the short-axis direction are connected to respective long portions 30 of the side wall 3, which will be described later.

The bottom joining portion 20 is located substantially in the middle of the first internal rib 21 in the long-axis direction and substantially in the middle of the second internal rib 22 in the short-axis direction. In other words, the first and the second internal ribs 21, 22 extend to intersect with each other at the bottom joining portion 20. This means that the first and the second internal ribs 21, 22 each extend from the side wall 3 to the bottom joining portion 20. More specifically, each of the first and the second internal ribs 21, 22 has wall-shaped portions on the respective sides of the bottom joining portion 20, and the wall-shaped portions are connected to the bottom joining portion 20.

The number, the location, and the shape of the internal rib(s) provided on the bottom surface 2 are not limited to those described above and may be suitably determined. Specifically, for example, the bottom surface 2 may be provided with either one of the first internal rib 21 or the second internal rib 22, or may be provided with none of the first and the second internal ribs 21, 22. In addition, in a case, for example, where the bottom joining portion 20 is formed as a bolt hole in the bottom surface 2, the internal rib(s) may extend to the edge of the bolt hole.

### (3) Side Wall

The side wall 3 is a wall-shaped portion protruding upward from the edge portion of the bottom surface 2 and surrounding the edge portion (see FIGS. 1 to 6). The side wall 3 includes two long portions 30, the first and the second short portions 31, 32, and a first to a third external rib 33 to 35 arranged on each long portion 30. The side wall 3 forms an opening 36 on the opposite side of the bottom surface 2. The opening is surrounded by the upper ends of the two long portions 30 and the upper ends of the first and the second short portions 31, 32.

### <Long Portion>

Each long portion 30 protrudes from a portion of the edge portion of the substantially rectangular bottom surface 2 that forms a side of the edge portion extending in the long-axis direction, and the long portions 30 face each other in the short-axis direction (see FIGS. 1 to 4). More specifically, each long portion 30 is inclined with respect to the up-down direction so that the distance between the long portions 30 increases as the long portions 30 extend away from the bottom surface 2. Each long portion 30 is connected to a first to a third intermediate portion 41 to 43 of the upper joining portion 4, which will be described later, and extends in a planner manner.

Furthermore, each long portion 30 includes a substantially rectangular first portion 30A and a substantially triangular second portion 30B. The first portion 30A is located on the upper side of the bottom surface 2, and the second portion 30B is located on the inner side of the first portion 30A. The second portion 30B is arranged so that the second portion 30B widens toward its top, and the end of the second portion 30B defining the border with the second short portion 32 forms one side of a triangle and linearly extends upward at an angle from the inner end of the bottom surface 2.

### <First and Second Short Portions>

Each of the first and the second short portions 31, 32 protrudes from a portion of the edge portion of the substantially rectangular bottom surface 2 that forms a side of the edge portion extending in the short-axis direction; the first and the second short portions 31, 32 extend in a planner manner and face each other in the long-axis direction (see FIGS. 1 to 6). More specifically, the first short portion 31 is located on the outer side and connected to the outer ends of the first portions 30A of the long portions 30, and the second short portion 32 is located on the inner side and connected to the inner ends of the second portions 30B of the long portions 30. The first and the second short portions 31, 32 are inclined with respect to the up-down direction so that the distance therebetween increases as the first and the second short portions 31, 32 extend away from the bottom surface 2. The degree of inclination of the second short portion 32 with respect to the up-down direction is greater than that of the first short portion 31.

### <First to Third External Ribs>

The first to the third external ribs 33 to 35 are wall-shaped portions protruding from the external lateral surface of the first portion 30A of each long portion 30. The first to the third external ribs 33 to 35 extend in respective directions that substantially align with the up-down direction, and are arranged side by side at roughly equal intervals from the outer side to the inner side (in other words, along the long-axis direction) (see FIGS. 1, 2, and 4 to 6). The first external rib 33 is located at the outer end of the first portion 30A, the second external rib 34 is located substantially in the middle of the first portion 30A in the long-axis direction, and the third external rib 35 is located at the inner end of the first portion 30A.

The first to the third external ribs 33 to 35 of each long portion 30 have the same configuration. Specifically, each of the first to the third external ribs 33 to 35 has a triangular shape, and the upper end is connected to the first intermediate portion 41 of the upper joining portion 4, which will be described later. The apex portion of each of the first to the third external ribs 33 to 35 forms a side of a triangle, and the height between the long portion 30 and the apex portion decreases toward the bottom surface 2. The upper end of the apex portion is located at an end of the first intermediate portion 41. The lower end of the apex portion forms the lower end of the external rib and is located in the long portion 30 and in the vicinity of and above the bottom surface 2.

The outermost first external ribs 33, the first short portion 31, and an outer portion 40 of the upper joining portion 4, which will be described later, extend so as to form a substantially single plane. The innermost third external ribs 35 and the second intermediate portions 42 of the upper joining portion 4, which will be described later, extend so as to form a substantially single plane.

The number, the location, and the shape of the external rib(s) provided on each long portion 30 are not limited to those described above and may be suitably determined. In each long portion 30, in addition to or in place of the first portion 30A, the second portion 30B may be provided with an external rib(s). Each long portion 30 may be provided with no external rib.

### (4) Upper Joining Portion

The upper joining portion 4 is a flange-shaped portion arranged at the upper end of the side wall 3 and configured to be joined to the floor member 6 and the side member 7 (see FIGS. 1 to 6). The upper joining portion 4 includes the outer portion 40, the two first intermediate portions 41, the two second intermediate portions 42, the two third intermediate portions 43, and an inner portion 44, and these portions form one continuous portion surrounding the opening 36 of the side wall 3. Such a configuration of the upper joining portion 4 is merely an example, and the shape of the upper joining portion 4 may be suitably determined depending on the shape(s) of the framework member(s) to which the bracket 1 will be joined.

### <Outer Portion>

The outer portion 40 is located at the outer end of the bracket 1 in the long-axis direction (see FIGS. 1 to 4 and 6). The outer portion 40 is located at the upper end of the first short portion 31 and inclined with respect to the up-down direction similarly to the first short portion 31.

### <First to Third Intermediate Portions>

The two first intermediate portions 41 are each located at the upper end of the first portion 30A of the long portion 30. The two first intermediate portions 41 extend inward from the respective ends of the outer portion 40 along the long-axis direction of the bracket 1 and face each other in the short-axis direction (see FIGS. 1 to 6). The length of each first intermediate portion 41 in the long-axis direction is comparable with that of the bottom surface 2.

The two second intermediate portions 42 are each located at the outer end of the second portion 30B of the long portion 30, and extend upward from the inner end of the first intermediate portion 41. In one example, each second intermediate portion 42 is inclined inward with respect to the up-down direction as the second intermediate portion 42 extends away from the first intermediate portion 41. In addition, the two second intermediate portions 42 face each other in the short-axis direction and face the outer portion 40 in the long-axis direction.

The two third intermediate portions 43 are each located at the upper end of the second portion 30B of the long portion 30, and extend inward from the upper end of the second intermediate portion 42 along the long-axis direction. The two third intermediate portions 43 face each other in the short-axis direction. In addition, the two third intermediate portions 43 are located above the two first intermediate portions 41 and the outer portion 40 and located laterally to these portions.

### <Inner Portion>

The inner portion 44 is located at the inner end of the bracket 1 in the long-axis direction (see FIGS. 1 to 6). The inner portion 44 is located at the upper end of the second short portion 32 and extends such that the inner portion 44 and each third intermediate portion 43 form a substantially single plane.

### <Joining of Upper Joining Portion>

The upper joining portion 4 is configured to be joined to the side member 7 and the floor member 6 by adhesive joining and mechanical joining. Examples of the mechanical joining may include bolting, friction welding, and riveting. In one example, the outer portion 40, each first intermediate portion 41, and each second intermediate portion 42 constitute a first upper joining portion that is configured to be joined to the side member 7, and each third intermediate portion 43 and the inner portion 44 constitute a second upper joining portion that is configured to be joined to the floor member 6 (see FIG. 1).

Specifically, an adhesive is applied to the outer portion 40, each first intermediate portion 41, each second intermediate portion 42, each third intermediate portion 43, and the inner portion 44; these portions are joined to the side member 7 and the floor member 6 by the adhesive. Each first intermediate portion 41, each second intermediate portion 42, each third intermediate portion 43, and the inner portion 44 are provided with joining portions 4A (see FIG. 3). Following the adhesive joining, the joining portions 4A are joined to the side member 7 or the floor member 6 by the mechanical joining.

The upper joining portion 4 may be joined to the side member 7 and the floor member 6 by, for example, any one of the adhesive joining or the mechanical joining.

The respective portions of the side member 7 and the floor member 6 to be joined to the upper joining portion 4 may be formed of iron. More specifically, these portions may be formed of, for example, high-tensile steel having a tensile strength of 590 MPa or more. These portions may be formed of super high-tensile steel having a tensile strength of 1470 MPa or more.

### 2. Second Embodiment

### (1) Overview

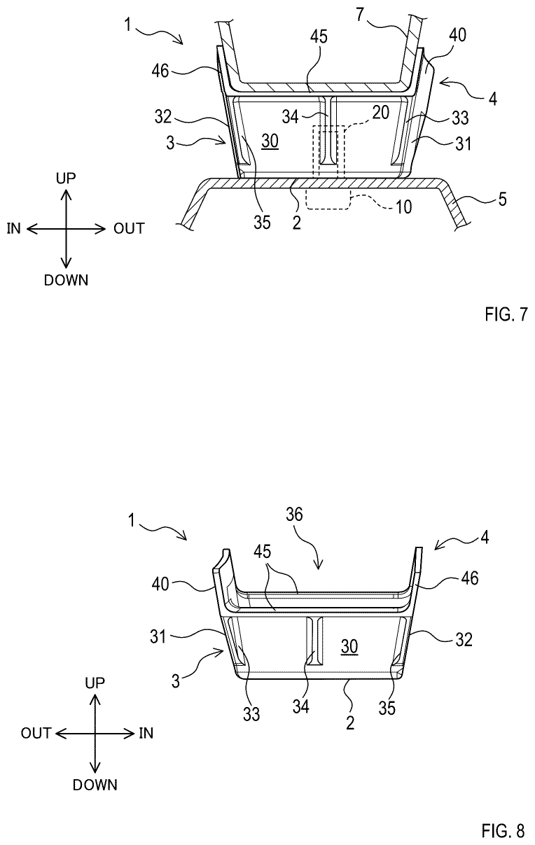

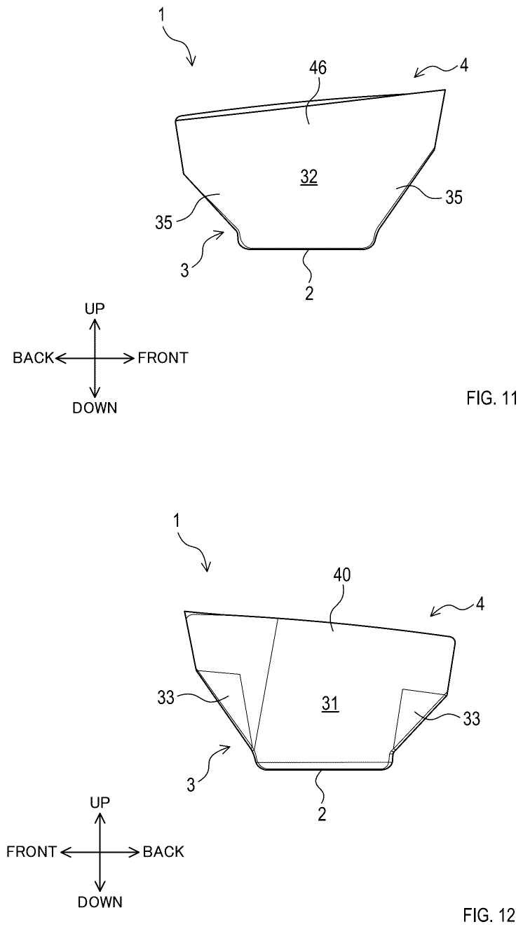

The bracket 1 according to a second embodiment has a configuration similar to that in the first embodiment, but differs from the bracket 1 according to the first embodiment in that the bracket 1 is configured to join the suspension member 5 and the side member 7 (see FIGS. 7 to 12). The bracket 1 according to the second embodiment may be configured to join the suspension member 5 to a framework member other than the side member 7.

Specifically, the bracket 1 according to the second embodiment differs from the bracket 1 according to the first embodiment in that its length in the left-right direction, in other words the long-axis direction according to the first embodiment, is shorter than that in the first embodiment, and that the side wall 3 and the upper joining portion 4 are configured differently from those in the first embodiment. The following description illustrates the difference between the bracket 1 according to the second embodiment and the bracket 1 according to the first embodiment.

### (2) Side Wall

The side wall 3 of the second embodiment includes the two long portions 30, the first and the second short portions 31, 32, but differs from that of the first embodiment in the configurations of each long portion 30 and the second short portion 32 (see FIGS. 7 to 12).

Specifically, the long portion 30 of the second embodiment does not have the second portion 30B of the long portion 30 according to the first embodiment and is composed of a portion corresponding to the first portion 30A. In other words, the long portion 30 of the second embodiment has a substantially rectangular shape, extends in the left-right direction, and is located on the upper side of the bottom surface 2.

The second short portion 32 is connected to the inner end of each long portion 30 and faces the first short portion 31. The second short portion 32 has a degree of inclination with respect to the up-down direction comparable with that of the first short portion 31 and extends away from the first short portion 31 as the second short portion 32 extends upward.

The first to the third external ribs 33 to 35 have the same configuration as in the first embodiment. The first external rib 33 is located at the outer end of the long portion 30, the second external rib 34 is located substantially in the middle of the long portion 30 in the long-axis direction, and the third external rib 35 is located at the inner end of the long portion 30.

### (3) Upper Joining Portion

The upper joining portion 4 of the second embodiment includes the outer portion 40, two intermediate portions 45, and an inner portion 46, and these portions form one continuous flange-shaped portion surrounding the opening 36 of the side wall 3 (see FIGS. 7 to 12).

The outer portion 40 is located at the outer end of the bracket 1 and configured in the same manner as in the first embodiment.

The two intermediate portions 45 are each located at the upper end of the long portion 30. The two intermediate portions 45 extend inward from the respective ends of the outer portion 40 to the inner portion 46 along the long-axis direction of the bracket 1 and face each other in the front-rear direction of the vehicle. The length of each intermediate portion 45 in the left-right direction is comparable with that of the bottom surface 2 in the left-right direction.

The inner portion 46 is located at the inner end of the bracket 1 and extends so as to connect the inner ends of the respective intermediate portions 45. The inner portion 46 is located at the upper end of the second short portion 32 and face the outer portion 40 in the left-right direction. The inner portion 46, the second short portion 32, and the third external rib 35 of each long portion 30 extend so as to form a substantially single plane.

### (4) Joining of Upper Joining Portion

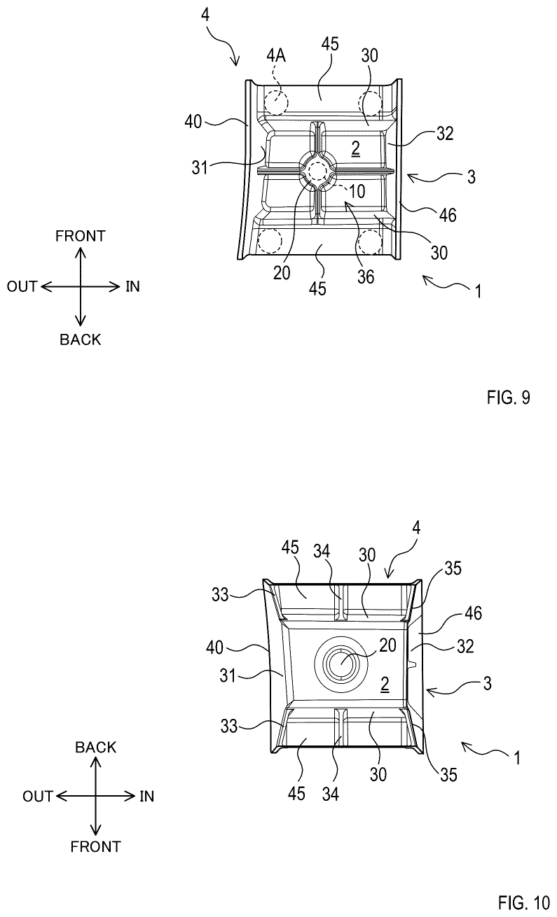

The upper joining portion 4 is configured to be joined to the side member 7 by adhesive joining and mechanical joining as in the first embodiment (see FIG. 7). Specifically, an adhesive is applied to the outer portion 40, each intermediate portion 45, and the inner portion 46; these portions and the side member 7 are joined to each other by the adhesive. Each intermediate portion 45 is provided with joining portions 4A (see FIG. 9). Subsequently, the joining portions 4A and the side member 7 are joined to each other by the mechanical joining. The upper joining portion 4 may be joined to the side member 7 by, for example, any one of the adhesive joining or the mechanical joining as mentioned in the first embodiment.

### 3. Effects

(1) According to the aforementioned embodiments, the bracket 1 is integrally formed by aluminum die casting. This makes it possible to reduce the number of components, improve the stiffness, and facilitate lightweighting. Furthermore, the first and the second internal ribs 21, 22 protruding from the bottom surface 2 are arranged inside of the side wall 3. This configuration improves the stiffness of the bracket 1. Therefore, it is possible to facilitate reduction of the assembly workload and lightweighting.

Improved stiffness of the bracket 1 can improve driving safety and ride comfort of the vehicle.

Furthermore, the aforementioned embodiments can be regarded as partial utilization of integral forming by aluminum die casting in which the integral forming is utilized for the bracket 1 which corresponds to a portion of a framework member, rather than for a framework member such as the suspension member 5. This allows more use of the structures of conventional framework members, thus enabling costs to be reduced and the bracket 1 to be used for various types of vehicles as compared to cases where the entirety of a framework member is formed by aluminum die casting.

(2) The first and the second internal ribs 21, 22 extend from the side wall 3 to the bottom joining portion 20. This configuration can improve the stiffness of the bracket 1. Furthermore, the first and the second internal ribs 21, 22 respectively extend linearly along the left-right direction and the front-rear direction of the vehicle (in other words, the long-axis direction and the short-axis direction of the bracket 1, respectively). This configuration improves the stiffness of the bracket 1 against loads in the left-right direction and the front-rear direction of the vehicle.

(3) Each long portion 30 is provided with the first to the third external ribs 33 to 35. Thus, it is possible to improve the stiffness of the bracket 1.

(4) The lower ends of the first to the third external ribs 33 to 35 are spaced from the bottom surface 2. Thus, it is possible to facilitate lightweighting of the bracket 1, while inhibiting a reduction in the stiffness thereof.

(5) The bracket 1 according to the first embodiment is configured to be joined to the side member 7 by the outer portion 40, each first intermediate portion 41, and each second intermediate portion 42, and joined to the floor member 6 by each third intermediate portion 43 and the inner portion 44. Thus, it is possible to facilitate reduction of the assembly workload and lightweighting, even in cases where the bracket 1 is configured to be joined to multiple members.

(6) Each long portion 30 of the bracket 1 according to the first embodiment extends from a portion of the edge portion of the bottom surface 2 extending in the long-axis direction to the first to the third intermediate portions 41 to 43 in a planner manner. Thus, it is possible to improve the stiffness of the bracket 1 against a load in the left-right direction of the vehicle (in other words, the long-axis direction of the bracket 1).

### 4. Other Embodiments

(1) The bracket 1 according to the first embodiment may be joined to two framework members other than the floor member 6 and the side member 7, or may be joined to the floor member 6 or the side member 7 and another framework member. The bracket 1 according to the second embodiment may be joined to a framework member other than the side member 7. In addition, the bracket 1 according to the first embodiment may be configured to join the suspension member 5 and three or more framework members.

(2) The bracket 1 according to the first and the second embodiments may be configured to join a suspension member arranged around suspensions of front wheels of the vehicle and at least one framework member.

(3) Two or more functions of a single element in the above-described embodiments may be achieved by two or more elements, and a single function of a single element may be achieved by two or more elements. Two or more functions achieved by two or more elements may be achieved by a single element, and a single function achieved by two or more elements may be achieved by a single element. A part of the configurations in the above-described embodiments may be omitted. At least a part of the configurations in the above-described embodiments may be added to or replaced with the configuration in another one of the above-described embodiments.

### 5. Correspondence Relationships of Terms

The floor member 6 and the side member 7 in the first embodiment respectively correspond to an example of a first member and an example of a second member.

### 6. Technical Idea Disclosed in Present Specification

### [Item 1]

A bracket to be mounted in a vehicle, the bracket including:
a bottom surface configured to be arranged to face a suspension member;
a bottom joining portion arranged at the bottom surface and configured to join the suspension member to the bottom surface;
a side wall that is a wall-shaped portion protruding upward from an edge portion of the bottom surface and surrounding the edge portion;
an upper joining portion arranged at an upper end of the side wall and configured to be joined to a member constituting a portion of a framework of the vehicle; and
an internal rib that is a wall-shaped portion protruding upward from the bottom surface,
the bracket being an integrally-formed member and formed of aluminum or aluminum alloy.

### [Item 2]

The bracket according to Item 1, wherein
the internal rib extends from the side wall to the bottom joining portion.

### [Item 3]

The bracket according to Item 1 or 2, further including
an external rib that is a wall-shaped portion protruding from an external lateral surface of the side wall and extending in a direction substantially aligns with an up-down direction.

### [Item 4]

The bracket according to Item 3, wherein
a lower end of the external rib is located above the bottom surface.

### [Item 5]

The bracket according to any one of Items 1 to 4, wherein
the upper joining portion includes a first upper joining portion and a second upper joining portion located laterally to the first upper joining portion,
the first upper joining portion is configured to be joined to a first member included in a framework of the vehicle, and
the second upper joining portion is configured to be joined to a second member that is included in the framework of the vehicle and is different from the first member.

### [Item 6]

The bracket according to Item 5, wherein
the side wall includes a long portion extending in a planar manner from the edge portion of the bottom surface to the first upper joining portion and the second upper joining portion.

What is claimed is:

1. A bracket to be mounted in a vehicle, the bracket comprising:
a bottom surface configured to be arranged to face a suspension member;
a bottom joining portion arranged at the bottom surface and configured to join the suspension member to the bottom surface;
a side wall that is a wall-shaped portion protruding upward from an edge portion of the bottom surface and surrounding the edge portion;
an upper joining portion arranged at an upper end of the side wall and configured to be joined to a member constituting a portion of a framework of the vehicle; and
an internal rib that is a wall-shaped portion protruding upward from the bottom surface,
the bracket being an integrally-formed member and formed of aluminum or aluminum alloy.

2. The bracket according to claim 1, wherein the internal rib extends from the side wall to the bottom joining portion.

3. The bracket according to claim 1, further comprising an external rib that is a wall-shaped portion protruding from an external lateral surface of the side wall and extending in a direction substantially aligns with an up-down direction.

4. The bracket according to claim 3, wherein a lower end of the external rib is located above the bottom surface.

5. The bracket according to claim 1, wherein
the bottom surface is a substantially rectangular plate-shaped portion, and
the side wall includes four planar portions each protruding from a portion of the edge portion of the bottom surface, the portion of the edge portion forming a side of the edge portion.

6. The bracket according to claim 5, wherein the upper joining portion is a flange-shaped portion arranged at upper ends of the four planar portions of the side wall.

7. The bracket according to claim 1, wherein
the upper joining portion includes a first upper joining portion and a second upper joining portion located laterally to the first upper joining portion,
the first upper joining portion is configured to be joined to a first member included in the framework of the vehicle, and
the second upper joining portion is configured to be joined to a second member that is included in the framework of the vehicle and is different from the first member.

8. The bracket according to claim 7, wherein the side wall includes a long portion extending in a planar manner from the edge portion of the bottom surface to the first upper joining portion and the second upper joining portion.

9. The bracket according to claim 7, wherein
the bottom surface is a substantially rectangular plate-shaped portion, and
the side wall includes two long portions each extending in a planar manner from a respective one of two portions of the edge portion of the bottom surface to the first upper joining portion and the second upper joining portion, the two portions of the edge portion forming long sides of the edge portion.

10. The bracket according to claim 9, wherein
the second upper joining portion is located above the first upper joining portion,
the two long portions each includes a first portion and a second portion, the first portion having a substantially rectangular shape and being located on an upper side of the bottom surface, the second portion having a substantially triangular shape and being located laterally to the first portion,
the second portion widens toward a top thereof,
the first upper joining portion is arranged at an upper end of the first portion, and
the second upper joining portion is arranged at an upper end of the second portion.
